(19) United States
(12) Patent Application Publication
(10) Pub. No.: US 2018/0329792 A1
(43) Pub. Date: Nov. 15, 2018

(54) NETWORK DEVICE MONITORING

(71) Applicant: Microsoft Technology Licensing, LLC, Redmond, WA (US)

(72) Inventors: Gueorgui B. CHKODROV, Redmond, WA (US); Douglas M. SETSER, Sammamish, WA (US); Mark Christopher MANN, Seattle, WA (US); Jose Wilson MORRIS, Bothell, WA (US); Jonathan P. MORRIS, Duvall, WA (US); Sanjay Kumar SINHA, Redmond, WA (US); Kevin M. GRADY, Sammamish, WA (US)

(73) Assignee: Microsoft Technology Licensing, LLC, Redmond, WA (US)

(21) Appl. No.: 15/595,197

(22) Filed: May 15, 2017

(51) Int. Cl. G06F 11/30; G06F 11/07; H04L 12/24; H04L 12/26; G06F 9/44

(52) U.S. Cl. CPC G06F 11/3041; G06F 11/0736; G06F 11/3082; G06F 15/173; H04L 43/0817; G06F 9/4428; G06F 11/3006; H04L 41/0681

(57) ABSTRACT

A network standards file comprises information associated with a set of events and network variables associated with the device. An event and a network variable to be monitored are selected based on a user input. A template object file is generated based on at least one of the network variable and event. Network data from a network device is obtained based on the template object file. A storage schema is generated based on the template object file and the network data. The network data is stored based on the storage schema for monitoring the network device.

### BACKGROUND

Enterprise networks generally include a large number of network devices, for example, digital devices and optical devices, which are manufactured by different vendors. Such network devices are monitored to ensure the smooth operation of the enterprise network. For monitoring the network devices, data generated by the network devices may be captured and subsequently analyzed for detecting faults, errors, breakdowns, and other anomalies.

Network devices typically generate standard data, i.e., data specific to a defined standard, and also data specific to the vendor, model, and/or version of a network device. Existing products for monitoring utilize standard data or are designed specifically to utilize data particular to a specific vendor, model, and/or version of the network device. One will appreciate that the products that use standard data for monitoring are limited in utility and scalability as they cannot monitor data particular to the vendor, model, and/or version of the network device. Similarly, the products that are designed to utilize data from a particular vendor, model, and/or version of the network device are also limited in utility and scalability as they cannot be used for monitoring data specific to other vendors. There is therefore a need for a solution that allows a user such as, a network engineer, to choose the device data of interest to be monitored, be it standard device data or vendor-specific device data and provides such data for monitoring via standard tools.

### BRIEF DESCRIPTION OF THE DRAWINGS

Example embodiments are described in detail in the following description with reference to the following figures. The example embodiments are illustrated in the accompanying figures in which like reference numerals indicate similar elements.

FIG. 1 illustrates a system for monitoring network devices according to an example embodiment.

FIG. 2A illustrates a user interface for browsing events a device can emit according to an example embodiment.

FIG. 2B illustrates counters that can be retrieved remotely from a device according to an example embodiment.

FIG. 2C illustrates a user interface to select devices to be polled according to an example embodiment.

FIG. 2D illustrates data collected from counters according to an example embodiment.

FIG. 3 illustrates a system for monitoring network devices according to an example embodiment

FIG. 4 illustrates a method of monitoring network devices according to an example embodiment.

FIG. 5 illustrates a computer system according to an example embodiment.

### DETAILED DESCRIPTION

For simplicity and illustrative purposes, the present disclosure is described by referring to example embodiments. In the following description, numerous specific details are set forth in order to provide an understanding of the example embodiments. However, it will be apparent to one of ordinary skill in the art, that the example embodiments may be practiced without limitation to these specific details. In some instances, well known methods and/or structures have not been described in detail so as not to unnecessarily obscure the description. Furthermore, the example embodiments may be used together in various combinations. In addition, the use of “a” or “an” before any element in the present disclosure and claims refers to at least one of that element.

According to examples of the present disclosure, a network standards file, such as, for example, a management information base (MIB) file, a yang file, and the like, comprising information related to a set of network variables is parsed. On parsing, the information is displayed to a user, such as, for example, a network engineer. Subsequently a network variable is selected based on a user input. In addition, or alternatively, at least one event from a set of events in the network standards file a network device can emit to be monitored is selected based on user input. Based on at least one of the network variable and event, a template object file is created and network data from a network device is obtained based on the template object file. In accordance with the present disclosure, the template object file is of a format such that the network data obtained based on the template object file may be stored in a table format.

In an example implementation, a structured storage schema is generated based on the template object file and the network data. The network data is subsequently stored based on the structured storage schema for monitoring the network device. Storing the network data in a structured storage schema format rather than in an unstructured manner such as a string may allow for the querying of the network data using standard data querying tools.

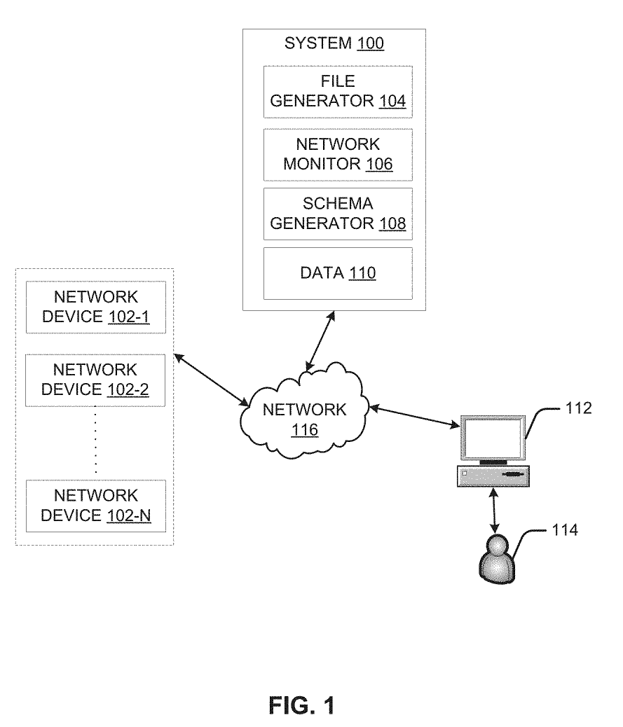

FIG. 1 illustrates an example embodiment of a system 100 for monitoring network devices. The system 100 may be implemented for monitoring network devices 102-1, 102-2, . . . , 102-N. In an example, the system 100 includes a file generator 104, a network monitor 106, a schema generator 108, and data storage 110.

In an example implementation, the file generator 104 may receive a network standards file, such as, for example, MIB file, a Yang file, a syslog file, and the like, from a computing device 112 of a user 114. The network standards file is specific to a network protocol and includes information, such as, for example, a description for a set of network variables associated with the network protocol. For instance, for a simple network management protocol (SNMP), a MIB file may be received by the file generator 104. The MIB file, in an example, may include network variables, such as, for example, counters and traps. Based on the network variables, the network devices may be monitored. Thus, for monitoring devices of a specific type, a network standards file specific to the network protocol supported by the devices is uploaded to the system 100 using the computing device 112.

In another example implementation, the file generator 104 may display a list of network standards files already uploaded on the system 100 to the user. The user may then select the network standards file from the list of network standards files.

An example network standards file is shown below for reference:

Example network standards file

```
ABC-SMI DEFINITIONS ::= BEGIN
IMPORTS
  MODULE-IDENTITY,
  OBJECT-IDENTITY,
  enterprises
    FROM SNMPv2-SMI;
ABC MODULE-IDENTITY
  LAST-UPDATED ″9704090000Z″
  ORGANIZATION ″ABC Systems, Inc.″
  CONTACT-INFO
    ″ABC Systems, Inc
  Customer Service
  Postal: 170 W Tasman Drive
  San Jose, CA 95134
  USA
  Tel: +1 800 553-NETS
  E-mail: cs-me1200@ABC.com″
  DESCRIPTION
    ″The Structure of Management Information for the
    ABC enterprise.″
  REVISION ″9704090000Z″
  DESCRIPTION
    ″Added ABCPartnerProducts to generate sysObjectID
    for partner platforms″
.
.
.
.
.
ABCChipSetSaint4 OBJECT-IDENTITY
  STATUS current
  DESCRIPTION
    ″The identity of the Rev 4 SAINT ethernet chipset
    manufactured for ABC by Mitsubishi.″
  ::= { ABCChipSets 4 }
END
```

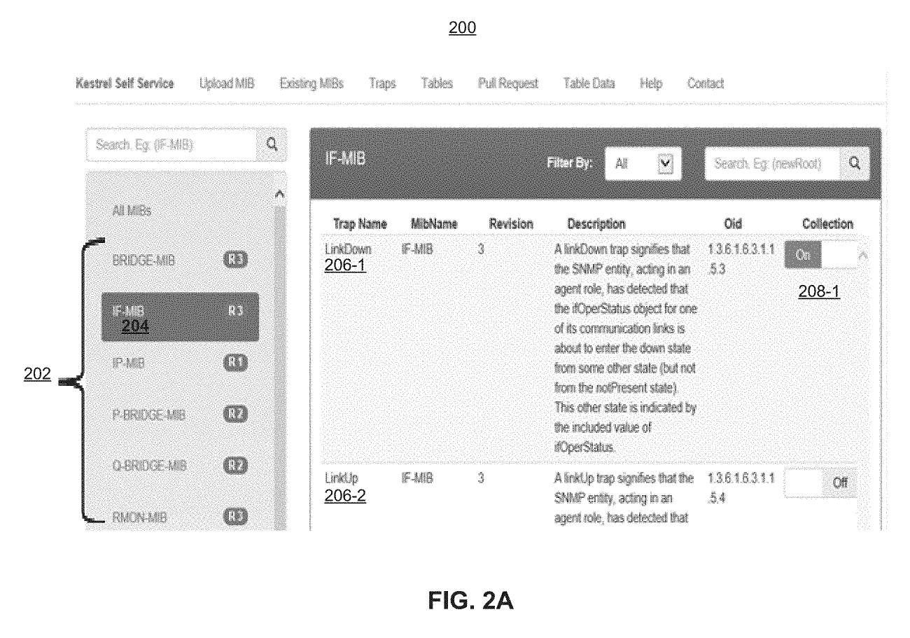

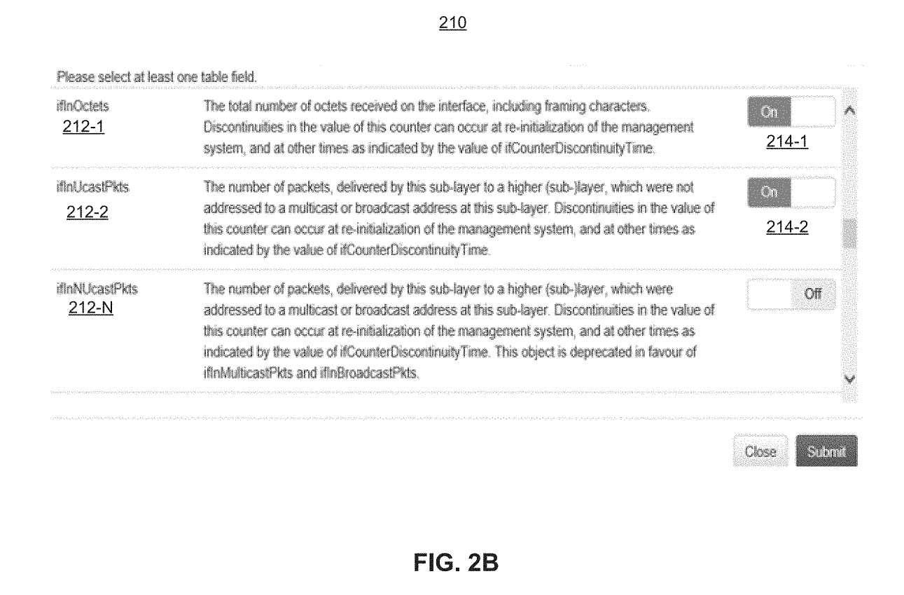

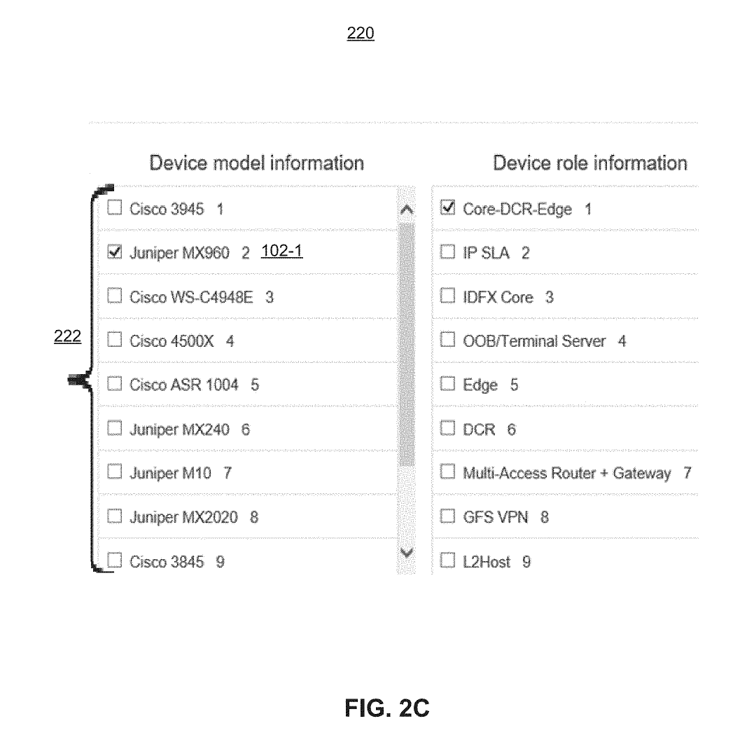

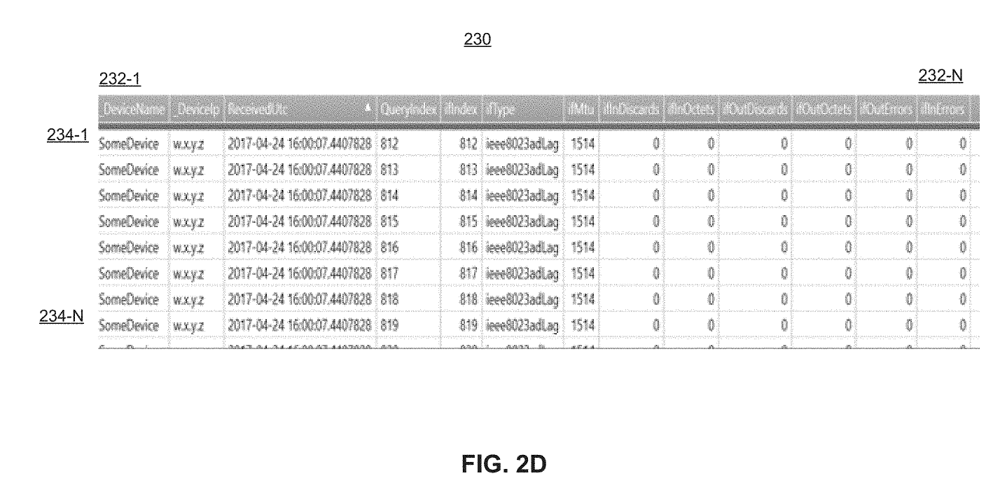

In an example implementation, the file generator 104 may parse the network standards file. In particular, the file generator 104 may parse the network standards file based on the imports defined in the network standards file. After parsing, the file generator 104 may display the information included in the network standards file to the user through a user interface 200, as shown in FIG. 2A. In an example, the file generator 104 may display the information in the same hierarchy in which the information is stored in the network standards file.

As shown in the FIG. 2A, the user interface 200 includes a list 202 of network standards files, the selected network standards file 204, events emitted by a network device 206-1 and 206-2. Furthermore, the user interface 200 includes information corresponding to the events emitted by a network device 206-1 and 206-2. For instance, as shown in the FIG. 2A, the user interface 200 displays a name of the network standards file 204, a version, a description, and an object identifier (OID) for each of the events 206-1 and 206-2 emitted by a network device. As shown in FIG. 2A, one of the network standards file 204 uploaded by the network engineer (or already available in system 100) is “IF-MIB”, the events emitted by a network device 206-1 and 206-2 within IF-MIB that can be monitored are Trap LinkDown and Trap LinkUp, respectively.

In an example embodiment, the file generator 104 may select a network variable or an event to be monitored from the set of variables and events that can be monitored based on a user input. For instance, when the list 202 is displayed to the user 114, the user 114 may provide a user input for selecting events emitted by the network device that can be monitored. As shown in the FIG. 2A, the event 206-1 is selected by the user. The selection of the event 206-1 is indicated by a status indicator 208-1, as shown in the FIG. 2A.

In another example embodiment, the network variable may be a run-time state such as, for example, counters. Counters may in turn include one or more fields. For example, if the network engineer uploaded network standards file “IF-MIB” and then selected a network variable for counters, the system 100 may depict various tables for IF-MIB. The various tables may include ifxTable, ifTable, and the like. Each table may include various fields. For example, the “ifTable” included in the network standards file for interface group may include one or more fields as depicted below:

Example fields of “ifTable”

SEQUENCE {

| | |
|---|---|
| ifIndex | InterfaceIndex, |
| ifDescr | DisplayString, |
| ifType | IANAifType, |
| ifMtu | Integer32, |
| ifSpeed | Gauge32, |
| ifPhysAddress | PhysAddress, |
| ifAdminStatus | INTEGER, |
| ifOperStatus | INTEGER, |
| ifLastChange | TimeTicks, |
| ifInOctets | Counter32, |
| ifInUcastPkts | Counter32, |
| ifInNUcastPkts | Counter32, -- deprecated |
| ifInDiscards | Counter32, |
| ifInErrors | Counter32, |
| ifInUnknownProtos | Counter32, |
| ifOutOctets | Counter32, |
| ifOutUcastPkts | Counter32, |
| ifOutNUcastPkts | Counter32, -- deprecated |
| ifOutDiscards | Counter32, |
| ifOutErrors | Counter32, |
| ifOutQLen | Gauge32, -- deprecated |
| ifSpecific | OBJECT IDENTIFIER -- deprecated |
| } | |

In an example implementation, the file generator 104 may display the one or more fields of the network variable to the user, for example, through a interface 210, as shown in FIG. 2B. As shown in the FIG. 2B, the user interface 210 displays one or more fields 212-1, 212-2, . . . , 212-N. Subsequently, the file generator 104 may select a field from the one or more fields 212-1, 212-2, . . . , and 212-N, based on a user input. For instance, as shown in the FIG. 2B, the file generator 104 may select the fields 212-1, and 212-2 based on the user input. The selection of the fields 212-1 and 212-2 is indicated by status indicators 214-1 and 214-2, respectively.

Once the file generator 104 selects the network variable and optionally, one or more fields of the network variable, the file generator may display a list of network devices to the user 114 through a user interface 220, as shown in FIG. 2C. As shown in the FIG. 2C, the user interface 220 includes a list 222 of the network devices 102-1 to 102-N. When presented with the list, the user 114 may select a network device, such as, for example, the network device 102-1 through a user input. Based on the user input, the file generator 104, in an example implementation, assigns the network variable to the network device 102-1. That is, the network device 102-1 may be monitored based on the network variable.

In an example implementation, the file generator 104 generates a template object file based on at least the network variable. The template object file, in an example, includes metadata, such as information related to the network variable. For instance, the template object file may include one or more fields of the network variable selected by the user 114. Further, in an example, the template object file may include information, such as for example, a name, related to the network device 102-1. In an example, the template object file may be in an object-oriented programming language format such as, for example, a Java, C, C++, or C# format. An example template object file in C# format, generated based on “ifTable” network variable is shown below:

Example template object file

```
[CollectAs(Gather.Pull.SnmpBulkGet, ″UDP:161″)]
[CollectFrequency(″00:05:00″)]
[DeviceSet(″CISCO-MODEL_ABCD″)]
[Description(″A list of interface entries from ifTable.″)]
public class IfTable
{
  [AssignFromDeviceModel]
  public string @_DeviceName { get; set; }
  . . .
  [SnmpOid(″1.3.6.1.2.1.2.2.1.20″)]
  [Description(@″For packet-oriented interfaces, the number of outbound
packets that could not be transmitted because of errors. For character-
oriented or fixed-length interfaces, the number of outbound
transmission units that could not be transmitted because of errors.
Discontinuities in the value of this counter can occur at
re-initialization of the management system, and at other times as
indicated by the value of ifCounterDiscontinuityTime.″)]
  public System.UInt64? ifOutErrors { get; set; }
}
```

In an example implementation, after the generation of the template object file, the file generator 104 may create a table in the data storage 110. The data storage 110, in an example, may be a database. The table, in an example, represents the class object as one row of the table. A schema of an example table created in parallel to the example template object file is illustrated below:

Schema of an example table

```
CREATE TABLE [dbo].[IfTable]( [symbol]
  DeviceName] [varchar](256)NOT NULL, [symbol]
  CreationDateTime] [datetime] NOT NULL, [symbol]
  SysUpTime] [bigint] NOT NULL, [symbol]
  Address] [varchar](256) NOT NULL, [symbol]
  TableIndex] [varchar](256) NOT NULL,
  [ifIndex] [int] NULL,
  [ifType] [int] NOT NULL,
  [ifMtu] [int] NULL,
  [ifSpeed] [bigint] NULL,
  [ifPhysAddress] [varchar](256) NULL,
  [ifInOctets] [decimal](28, 0) NULL,
  [ifInDiscards] [decimal](28, 0) NULL,
  [ifInErrors] [decimal](28, 0) NULL,
  [ifOutOctets] [decimal](28, 0) NULL,
  [ifOutDiscards] [decimal](28, 0) NULL,
  [ifOutErrors] [decimal](28, 0) NULL );
```

In an example implementation, the network monitor 106 may obtain network data from the network device based on the template object file. For instance, the network monitor 106 may access the template object file and may read a class attribute of the template object file. An example class attribute of the example template object file mentioned above is depicted below:

Example class attribute

[CollectAs(Gather.Pull.SnmpBulkGet,″UDP:161″)]
[CollectFrequency(″00:05:00″)]
[CollectDeviceSet(″CISCO-MODEL_ABCD″)]
public class IfTable

Based on the class attribute, the network monitor 106 may identify a command, a protocol, and a port to be used for obtaining the network data from the network device. Furthermore, the network monitor 106, in an example, may also define a timer for obtaining the network data from the network device. On obtaining the network data, in an example, the network monitor 106 may instantiate one or more fields or objects of the template object file based on the network data. For instance, the network monitor 106 may map network data to properties of the network variable based on corresponding property attributes. Subsequently, the network monitor 106 stores the network data in the table in the data storage 110.

Furthermore, in an example, the network monitor 106 may access data inventory stored in the data storage 110 for instantiating one or more fields, such as for example, Devicename, Ipaddress, and the like, of the template object file. The device inventory includes information, such as, for example, a name, an IP address, port information, and the like, related to the network devices to be monitored.

In an example implementation, the schema generator 108 may generate a structured storage schema based on the template object file and the network data. Examples of the structured storage schema may include, but are not limited to, Structured Query Language (SQL), Cosmos, and Kusto. In an example, for generating the structured storage schema, the schema generator 108 may identify fragments of the network standards file structure in the template object file. As an example, when the network standards file is a MIB file, the schema generator 108 may identify fragments of MIB defining structures in the template object file. The schema generator 108 may then translate or convert the network standards file structure into table creation statements for generating the structured schema storage. An example template object file and an example structured storage schema generated based thereon are presented below:

Example template object file

| ifTable OBJECT-TYPE | | |
|---|---|---|
| SYNTAX SEQUENCE OF IfEntry | | |
| . . . | | |
| IfEntry ::= | | |
| SEQUENCE { | | |
| ifIndex | InterfaceIndex, | |
| ifDescr | DisplayString, | |
| ifType | IANAifType, | |
| ifMtu | Integer32, | |
| ifSpeed | Gauge32, | |
| ifPhysAddress | PhysAddress, | |
| ifAdminStatus | INTEGER, | |
| ifOperStatus | INTEGER, | |
| ifLastChange | TimeTicks, | |
| ifInOctets | Counter32, | |
| | ifInUcastPkts | Counter32, |

Example structured storage schema

```
CREATE TABLE [dbo].[IfTable]( [symbol]
  SysUpTime] [bigint] NOT NULL, [symbol]
  Address] [xml] NULL, [symbol]
  TableIndex] [varchar](256) NULL,
  [ifIndex] [int] NULL,
  [ifDescr] [varchar](256) NULL,
  [ifType] [int] NOT NULL,
  [ifMtu] [int] NULL,
  [ifSpeed] [bigint] NULL,
  [ifPhysAddress] [varchar](256) NULL,
  [ifAdminStatus] [int] NOT NULL,
  [ifOperStatus] [int] NOT NULL,
  [ifLastChange] [bigint] NULL,
  [ifInOctets] [decimal](28, 0) NULL
    [ifInUcastPkts] [decimal](28, 0) NULL,
```

In an example, the network data may be stored in the data storage 110 based on the structured storage schema. Based on the structured storage schema, the network data may be queried and analyzed for managing the network device 102-1. In an example, data querying tools like, MS Excel, Power BI, and the like may be used for analyzing the network data. An example table 230 showing how network device data is stored based on the storage schema is depicted in FIG. 2D. As shown in the FIG. 2D, the columns 232-1 to 232-N depicts the fields of the template object file. Furthermore, the rows 234-1 to 234-N comprise data corresponding to the columns 232-1 to 232-N.

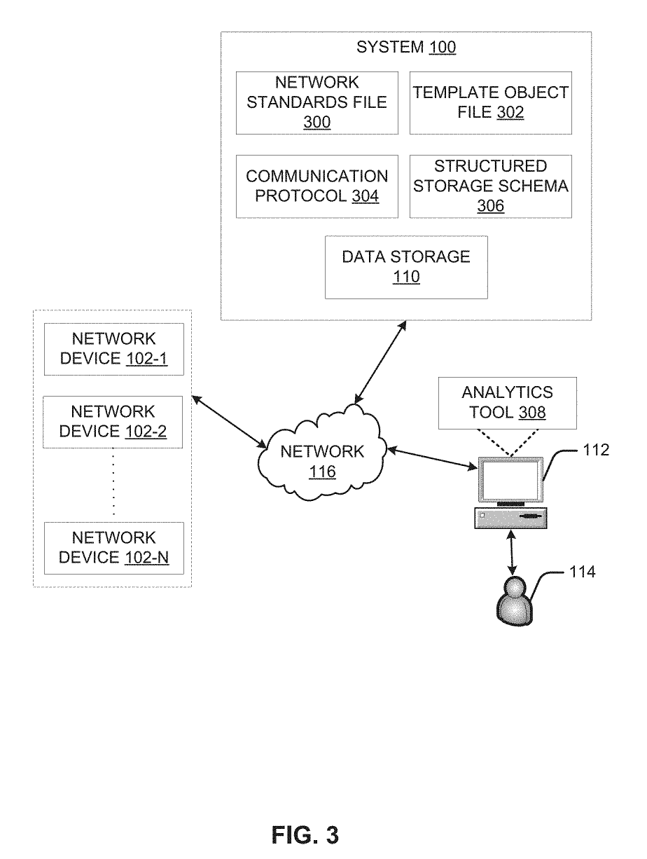

FIG. 3 illustrates the system 100 for monitoring devices according to another example embodiment. In an example, the user 114, for example, a network engineer, may seek to monitor one or more network devices from the network devices 102-1 to 102-N. For monitoring the one or more network devices, the network engineer may upload a network standards file 300, such as, for example, a MIB file, to the system 100 through the computing device 112. In another example, the system 100 may display a list of the network standards files already uploaded on the system 100 to the network engineer. In said example, the network engineer may select the network standards file 300 from the list of the network standards files.

Once the network standards file 300 is selected, the system 100 may parse the network standards file 300 based on imports included in the network standards file 300. Subsequently, the system 100 may display a set of network variables, such as, for example, counters and traps, included in the network standards file 300 to the network engineer through a display device (not shown in the figure) of the computing device 112. From the set of network variables, the network engineer may select one or more network variables to be used for monitoring the network devices. After receiving the selection of the network variables, the system 100 may display a list of the network devices 102-1 to 102-N to the network engineer, in an example. In said example, the network engineer may subsequently select the network devices which are to be monitored from the list of network devices 102-1 to 102-N. Based on the selection of the network devices, the system 100 assigns the network variables to the selected network devices.

In an example, the system 100 may generate a template object file 302 based on the network standards file 300. In an example, the template object file 302 may be in a C# format and may include metadata related to the network standards file 300. Based on the template object file 302, the system 100 may obtain network data related to the network devices to be monitored. In an example, the system 100 may use a communication protocol 304, such as, for example, an SNMP protocol and a REST protocol.

In an example, the system 100 may generate a structured storage schema 306 based on the template object file and the network data. The structured storage schema 306, in an example, may be in one of an SQL format, a Cosmos format, a Kusto format, and a Hadoop format. The system 100, in an example, may provide the structured storage schema 306 to the network engineer for analysis using the analytics tool 308, such as, for example, MS Excel, Power BI, and the like.

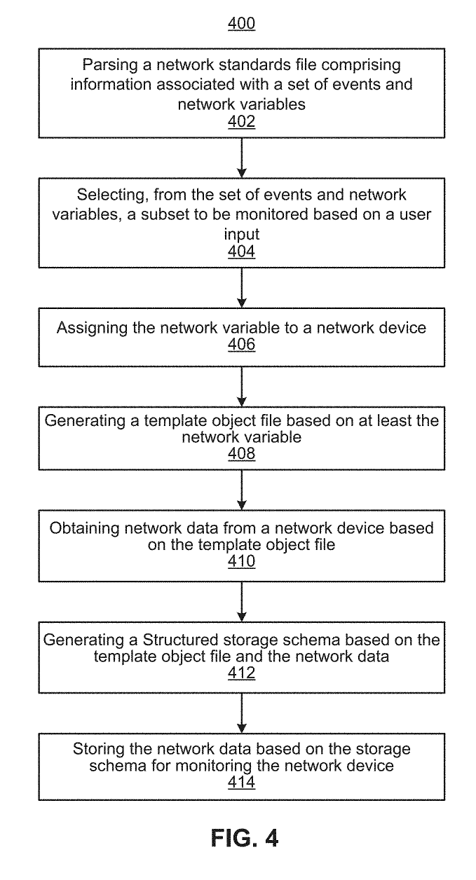

FIG. 4, illustrates flowchart of a method 400 for monitoring network devices according to an example embodiment. The method 400 is described by referring to components in FIG. 1. However, one of ordinary skill in the art will appreciate that method 400 may be accomplished by other hardware and/or software components without departing from the scope of the disclosure.

At 402, a network standards file comprising information associated with a set of network variables and events a device can emit is parsed. Examples of the network standard files may include a MIB file, a Yang file, a syslog file, and the like. Examples of the network variables may include, but are not limited to counters, and the like. Examples of events a device can emit are traps such as linkup and linkdown. In an example, the file generator 104 may parse the network standards file.

At 404, a network variable and/or an event to be monitored is selected from the set of network variables and events based on a user input. In an example, the set of variables and events may be displayed to a user through a display device. The user may provide the user input for selecting the network variable and/or event from the set of network variables and events, respectively. In an example, the file generator 104 may select the network variable based on the user input.

At 406, the network variable is assigned to a network device. In an example, the user may select the network device. Thereafter, the network variable is assigned to the network device selected by the user. In an example, the file generator 104 may assign the network variable to the network device 102-1.

At 408, a template object file is generated based on at least the network variable. In an example, the file generator 104 may generate the template object file. The template object file may in an object-oriented format such as, for example, a Java, C, C++, or C# format.

At 410, network data from the network device is obtained based on the template object file. In an example, the network monitor 106 may receive the network data based on the template object file. The network data may include information related to one or more fields specified in the template object file.

At 412, a structured storage schema is generated based on the template object file and the network data. In an example, the storage schema may be in any one of SQL, Cosmos, and Kusto format. In an example, the schema generator 108 may generate the storage schema.

At 414, the network data is stored based on the storage schema for monitoring the network device. In an example, the stored data may be analyzed using tools, such as, for example, MS Excel. In an example, the schema generator 108 may store the network data based on the storage schema for monitoring the network device.

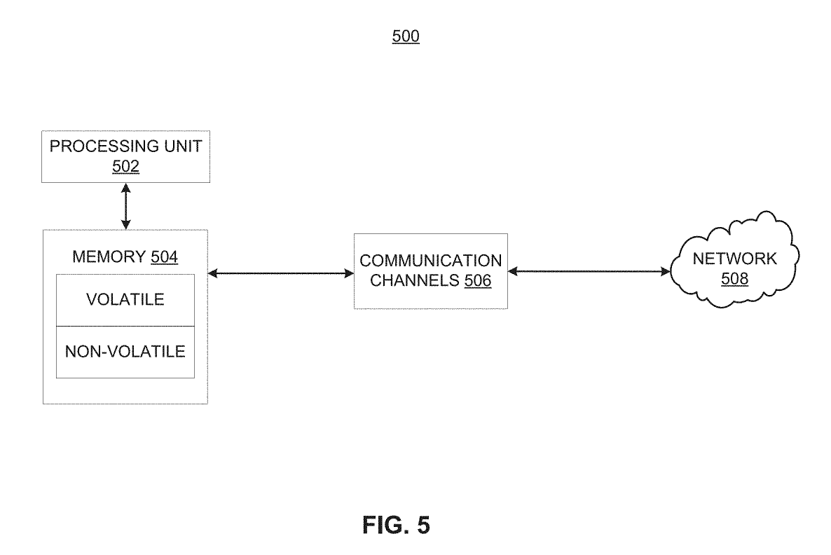

FIG. 5 illustrates a computer system 500 according to an embodiment. Embodiments described herein may comprise or utilize the system 500. Computer system 500 typically includes at least one processing unit 502 and memory 504. The memory 504 may be physical system memory, which may be volatile, non-volatile, or some combination of the two. The term “memory” may also be used herein to refer to non-volatile mass storage such as physical storage media. If the computer system 500 is distributed, the processing, memory and/or storage capability may be distributed as well. As used herein, the term “module” or “component” can refer to software objects or routines that execute on the computer system 500. The different components, modules, engines, and services described herein may be implemented as objects or processes that execute on the computer system 500 (e.g., as separate threads).

In the present disclosure, embodiments are described with reference to acts that are performed by one or more computing systems, such as the computer system 500. If such acts are implemented in software, one or more processors of the associated computing system that performs the acts direct the operation of the computing system in response to having executed computer-executable instructions. Within the context of the computer system 500, computer-executable instructions may be stored in the memory 504. Computer system 500 may also contain communication channels 506 that allow the computer system 500 to communicate with other message processors over a network 508.

Embodiments described herein also include physical and other computer-readable media for carrying or storing computer-executable instructions and/or data structures. Such computer-readable media can be any available media that can be accessed by a computer system. Computer-readable media that store computer-executable instructions are physical storage media. Computer-readable media that carry computer-executable instructions are transmission media.

Computer storage media includes recordable-type storage media, such as RAM, ROM, EEPROM, CD-ROM or other optical disk storage, magnetic disk storage or other magnetic storage devices, or any other medium that can be used to store desired program code means in the form of computer-executable instructions or data structures and which can be accessed by a computer system.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network (e.g., the network 508) and/or data links which can be used to carry or desired program code means in the form of computer-executable instructions or data structures and which can be accessed by a computing system. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media could be included in computer system components that also utilize transmission media.

Computer-executable instructions comprise, for example, instructions and data which, when executed at a processor, cause a computer or a processing device to perform a certain function or group of functions. The computer executable instructions may be, for example, binaries, intermediate format instructions such as assembly language, or even source code. Although the subject matter is described herein using language specific to structural features and/or methodological acts, it is to be understood that the subject matter defined in the appended claims is not necessarily limited to the described features or acts described herein. Rather, the features and acts described herein are disclosed as example forms of implementing the claims.

Those skilled in the art will appreciate that the present disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The present disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Although the processes illustrated and described herein include series of steps, it will be appreciated that the different embodiments of the present disclosure are not limited by the illustrated ordering of steps, as some steps may occur in different orders, some concurrently with other steps apart from that shown and described herein. In addition, not all illustrated steps may be required to implement a methodology in accordance with the present disclosure. Moreover, it will be appreciated that the processes may be implemented in association with the apparatus and systems illustrated and described herein as well as in association with other systems not illustrated.

Example embodiments are described above, and those skilled in the art will be able to make various modifications to the described embodiments and examples without departing from the scope of the embodiments and examples.

What is claimed is:

1. A system for monitoring network devices, the system comprising:
a file generator to:
parse a network standards file comprising information associated with a set of network variables;
select at least one event from a set of events in the network standards file based on a user input;
select, from the set of network variables, a network variable to be monitored based on a user input; and
generate a template object file based on at least one of the network variable and event; and
a network monitor to obtain network data from a network device based on the template object file; and
a schema generator to:
generate a structured storage schema based on the template object file and the network data; and
store the network data based on the structured storage schema for monitoring the network device.

2. The system as claimed in claim 1, wherein the file generator further is to receive the network standards file from a computing device.

3. The system as claimed in claim 1, wherein the file generator further is to:
display a list of network standards files to a user of a computing device; and
select the network standards file based on a user input.

4. The system as claimed in claim 1, wherein the file generator further is to assign the network variable to the network device based on a user input.

5. The system as claimed in claim 1, wherein the file generator further is to:
display one or more fields of the network variable to the user; and
select a field from the one or more fields based on a user input.

6. The system as claimed in claim 1, wherein the object template file is in an object-oriented programming language format.

7. The system as claimed in claim 1, wherein the file generator further is to:
create a table in a data source based on the template object file; and
store the network data in the table.

8. A method of monitoring network devices present in a network, the method comprising:
parsing a network standards file comprising information associated with a set of events and network variables;
selecting, from the set of events and network variables, a subset to be monitored based on a user input;
assigning the network variable to a network device;
generating a template object file based on at least the network variable;
obtaining network data from a network device based on the template object file;
generating a structured storage schema based on the template object file and the network data; and
storing the network data based on the structured storage schema for monitoring the network device.

9. The method as claimed in claim 8, wherein the method further comprises receiving the network standards file from a computing device.

10. The method as claimed in claim 8, wherein the method further comprises:
displaying a list of network standards files to a user of a computing device; and
selecting the network standards file based on a user input.

11. The method as claimed in claim 8, wherein the method further comprises:
displaying one or more fields of the network variable to the user; and
selecting a field from the one or more fields based on a user input.

12. The method as claimed in claim 8, wherein the object template file is in an object-oriented programming language format.

13. The method as claimed in claim 8, wherein the method further comprises
creating a table in a data source based on the template object file; and
storing the network data in the table.

14. A computer-readable storage medium including instructions that, when executed by a processor, cause the processor to:
parse a network standards file comprising information associated with a set of network variables;
select, from the set of network variables, a network variable to be monitored based on a user input;
generate a template object file based on at least the network variable;
obtain network data from a network device based on the template object file;
generate a structured storage schema based on the template object file and the network data; and
store the network data based on the storage schema for monitoring the network device.

15. The computer-readable medium of claim 14 further including instructions that, when executed by the processor, cause the processor to receive the network standards file from a computing device.

16. The computer-readable medium of claim 14 further including instructions that, when executed by the processor, cause the processor to:
display a list of network standards files to a user of a computing device; and
select the network standards file based on a user input.

17. The computer-readable medium of claim 14 further including instructions that, when executed by the processor, cause the processor to assign the network variable to the network device based on a user input.

18. The computer-readable medium of claim 14 further including instructions that, when executed by the processor, cause the processor to:
display one or more fields of the network variable to the user; and
select a field from the one or more fields based on a user input.

19. The computer-readable medium of claim 14, wherein the object template file is in an object-oriented programming language format.

20. The computer-readable medium of claim 14 further including instructions that, when executed by the processor, cause the processor to:
create a table in a data source based on the template object file; and
store the network data in the table.
